(19) United States
(12) Patent Application Publication
(10) Pub. No.: US 2014/0106292 A1
(43) Pub. Date: Apr. 17, 2014

(54) BRACKET FOR CORRECTING DENTOGNATHIC DEFORMITY

(71) Applicant: Haiping LU, Hangzhou (CN)

(72) Inventor: Haiping LU, Hangzhou (CN)

(21) Appl. No.: 14/055,859

(22) Filed: Oct. 16, 2013

Related U.S. Application Data
(63) Continuation-in-part of application No. 13/952,677, filed on Jul. 29, 2013.

(30) Foreign Application Priority Data
Oct. 16, 2012 (CN) 201210391827.0

(51) Int. Cl. A61C 7/30

(52) U.S. Cl. CPC A61C 7/30
USPC 433/11; 433/15

(57) ABSTRACT

This invention discloses a bracket for correcting dentognathic deformity including a substrate plate, a bracket body, and two working wings. The bracket body has an arch wire groove, and the working wings are located at two sides of the arch wire groove. The working wings have a ligature wire locating trench, and each wing has a ligature wire locating groove, groove bottom central lines of the ligature wire locating grooves are located on a same straight line. The bracket body has a ligature hole vertical to the arch wire groove and penetrating through the bracket body, and a vertical distance from a bottom surface of the arch wire groove to an upper surface of the substrate plate is larger than a height of the ligature hole. The bracket further has a C-shaped movable lock accessory. The placement and removement of the movable lock is convenient, greatly reducing the operation time.

### CROSS-REFERENCE TO RELATED APPLICATIONS

This Non-provisional application is a Continuation-in-Part of U.S. patent application Ser. No. 13/952677 filed on Jul. 29, 2013, which claims priority under 35 U.S.C. §119(a) on Patent Application No(s). 201210391827.0 filed in People's Republic of China on Oct. 16, 2012, the entire contents of which are hereby incorporated by reference.

### BACKGROUND OF THE INVENTION

1. Field of the Invention

The present invention belongs to the field of dental orthodontics and, more particularly, to a bracket for correcting dentognathic deformity.

2. Description of the Related Art

A bracket for correcting dentognathic deformity is an important component used in the correction of dentognathic deformity of a patient. In the traditional ligation method, the friction force between an arch wire and the bracket is relatively large, affecting the movement of teeth. To improve the above mentioned situation, a self-locking bracket has been developed and is available in the market. The self-locking bracket reduces the friction force between the arch wire and the bracket to a certain extent, but the self-locking bracket is complicated in structure and expensive in manufacturing. Besides, a locking plate of the self-locking bracket and the arch wire are in surface contact and in strong friction when stressed. More importantly, the self-locking bracket is unable to precisely control the locations of the teeth.

### BRIEF SUMMARY OF THE INVENTION

To solve the problems in the prior art, the present invention provides a bracket body and an accessory thereof, effectively reducing the friction force between the arch wire and the bracket, and the structure is simple and the operation is convenient. Meanwhile, by the bracket body and the accessory thereof in the invention, the friction force between the arch wire and the bracket and between the arch wire and the ligature wire can be adjusted by ligating different parts to achieve different correction effects.

The invention adopts the following technique solution. A bracket for correcting dentognathic deformity includes a substrate plate, a bracket body, and two working wings. The bracket body has an arch wire groove, and the two working wings are located at two sides of the arch wire groove. A lower part of the working wings has a ligature wire locating trench. Each of the working wings has a ligature wire locating groove, groove bottom central lines of the ligature wire locating grooves of the two working wings are located on a same straight line. The bracket body has a ligature hole vertical to the arch wire groove and penetrating through the bracket body, and a vertical distance from a bottom surface of the arch wire groove to an upper surface of the substrate plate is larger than a height of the ligature hole.

Preferably, the ligature hole is located under the ligature wire locating grooves.

Preferably, the same straight line formed by the groove bottom central lines of the ligature wire locating grooves of the two working wings is vertical to the arch wire groove.

Preferably, when the bracket is used for a central incisor or a lateral incisor, the size of the cross-sectional area of the arch wire groove is 0.018*0.025 inches, and when the bracket is used for a canine tooth, a premolar, or a molar, the size of the cross-sectional area of the arch wire groove is 0.020*0.025 inches.

Preferably, a vertical distance from a bottom of the ligature wire locating trench to the upper surface of the substrate plate is smaller than the vertical distance from the bottom surface of the arch wire groove to the upper surface of the substrate plate.

Preferably, in the bracket for correcting dentognathic deformity in the invention, two side surfaces, without the ligature hole disposed therein, of the bracket body are inclined inwardly from the top to the bottom of the bracket body.

The invention further provides a movable lock. The movable lock is C-shaped and is inserted with one end into the ligature hole and with the other end into the ligature wire locating grooves.

Preferably, the movable lock is made of an elastic material.

The invention has the following benefits and effects.

Since the bracket for correcting dentognathic deformity in the invention both have the ligature wire locating groove and the ligature hole vertical to the direction of the arch wire groove, different methods can be adopted during ligation. Therefore, the friction force between the arch wire and the bracket and between the arch wire and the ligature wire can be adjusted according to demands, and the torsion of the tooth can be adjusted by the ligation of different parts. Meanwhile, the movable lock can be inserted to the ligature hole and the ligature wire locating grooves according to therapeutic demands. The placement and removement of the movable lock is convenient, and the movable lock is elastic and can not drop easily, greatly reducing the operation time.

### BRIEF DESCRIPTION OF THE DRAWINGS

FIG. 1 is a structural schematic diagram showing a labial bracket for correcting dentognathic deformity in the present invention;

FIG. 2 is a top view of FIG. 1;

FIG. 3 is a structural schematic diagram showing a movable lock in the invention;

FIG. 4 is a structural schematic diagram showing one kind of ligation methods of the labial bracket in the invention;

FIG. 5 is a structural schematic diagram showing another kind of ligation methods of the labial bracket in the invention;

FIG. 6 is a structural schematic diagram showing another kind of ligation methods of the labial bracket in the invention;

FIG. 7 is a structural schematic diagram showing another kind of locking ligation methods of the labial bracket in the invention;

FIG. 8 is a structural schematic diagram showing another kind of ligation methods of the labial bracket in the invention;

FIG. 9 is a structural schematic diagram showing a lingual bracket for correcting dentognathic deformity in the invention;

FIG. 10 is a left view of FIG. 9;

FIG. 11 is a structural schematic diagram showing one kind of ligation methods of the lingual bracket in the invention;

FIG. 12 is a structural schematic diagram showing another kind of ligation methods of the lingual bracket in the invention;

FIG. 13 is a structural schematic diagram showing another kind of ligation methods of the lingual bracket in the invention;

FIG. 14 is a structural schematic diagram showing another kind of ligation methods of the lingual bracket in the invention; and

FIG. 15 is a structural schematic diagram showing another kind of locking ligation methods of the lingual bracket in the invention.

### DETAILED DESCRIPTION OF THE INVENTION

A bracket for correcting dentognathic deformity in the present invention can be used as a labial bracket or a lingual bracket.

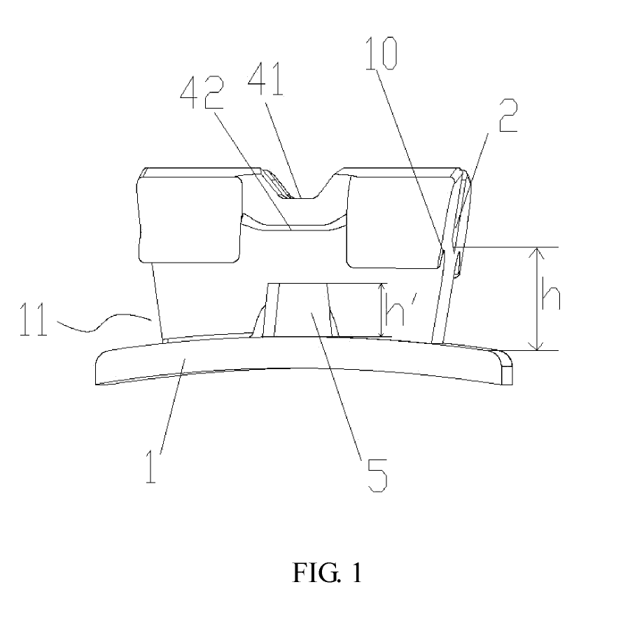

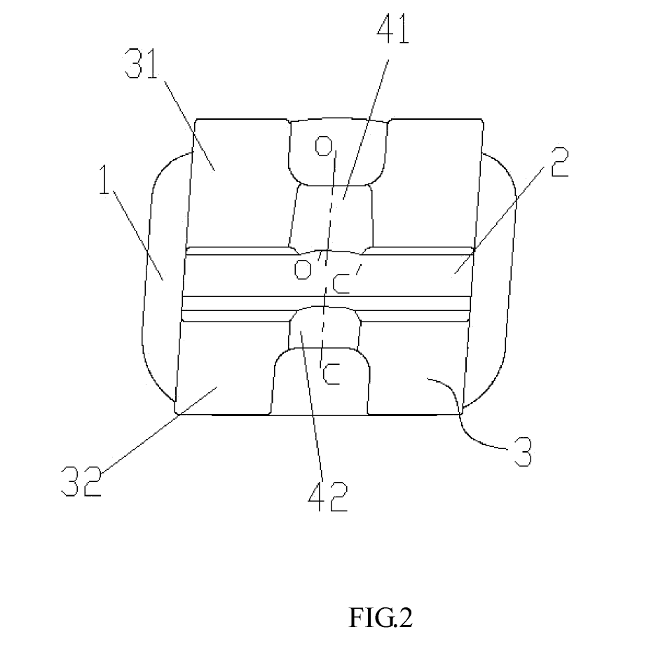

As shown in FIG. 1 and FIG. 2, the labial bracket for correcting dentognathic deformity of the present invention includes a substrate plate 1, a bracket body 11, and two working wings 31, 32. The bracket body 11 has an arch wire groove 2, and the working wing 31 and the working wing 32 are located at two sides of the arch wire groove 2. A lower part of the working wings 31, 32 has a ligature wire locating trench 10. The working wing 31 has a ligature wire locating groove 41, and the working wing 32 has a ligature wire locating groove 42. The groove bottom central line oo′ of the ligature wire locating groove 41 and the groove bottom central line cc′ of the ligature wire locating groove 42 are located on a same straight line. The same straight line is vertical to the arch wire groove 2. Certainly, in actual use, the same straight line may be at a certain angle to the arch wire groove 2 according to demands. As shown in FIG. 1, the bracket body 11 further has a ligature hole 5 vertical to the arch wire groove 2 and penetrating through the bracket body 11. A vertical distance h from a bottom surface of the arch wire groove 2 to an upper surface of the substrate plate 1 is larger than a height h′ of the ligature hole 5. The ligature hole 5 is located under the ligature wire locating groove 41 and the ligature wire locating groove 42. Further, as shown in FIG. 1, a vertical distance from a bottom of the ligature wire locating trench 10 to the upper surface of the substrate plate 1 is smaller than the vertical distance h from the bottom surface of the arch wire groove 2 to the upper surface of the substrate plate 1.

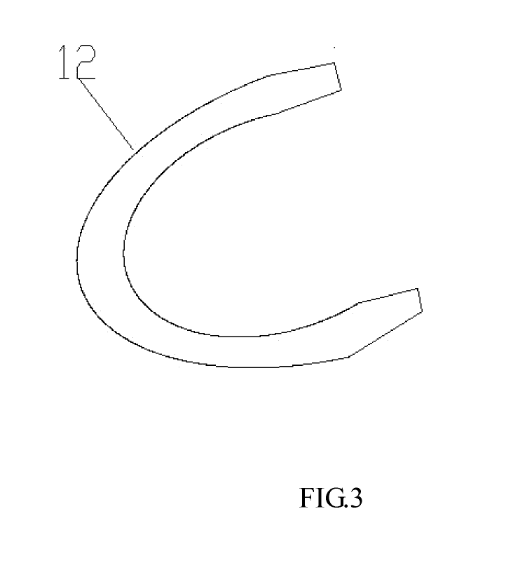

As shown in FIG. 3, a movable lock 12 is provided. The movable lock 12 is C-shaped. The movable lock 12 is made of an elastic material.

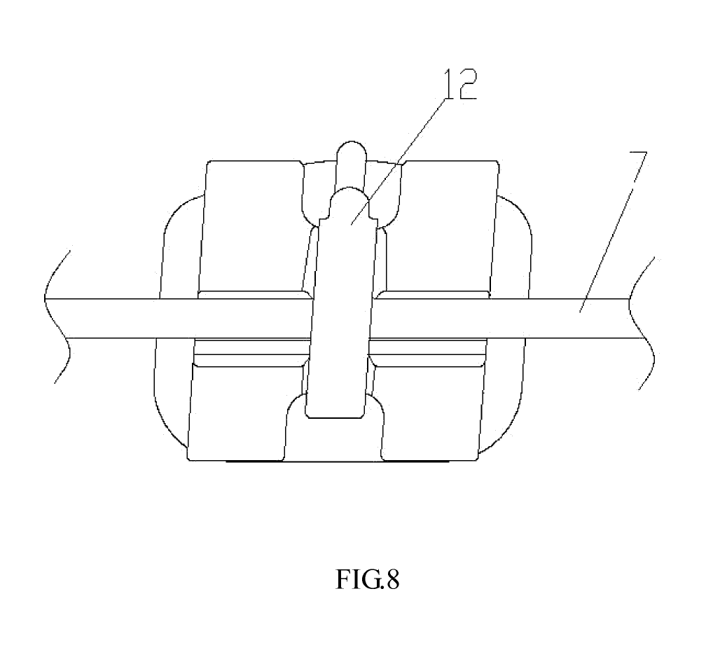

As shown in FIG. 8, the movable lock 12 can be inserted with one end into the ligature hole 5 and with the other end into the ligature wire locating groove.

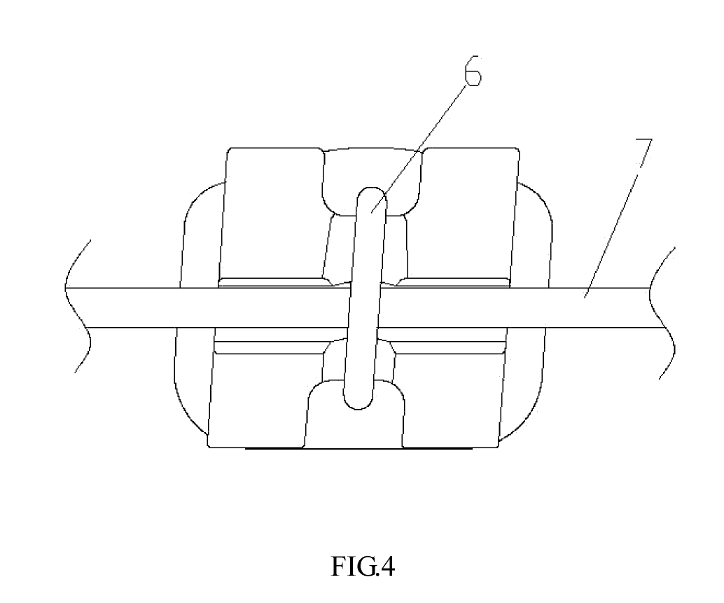

As shown in FIG. 4 to FIG. 8, the invention can adjust the friction force between the arch wire and the bracket and between the arch wire and a ligature wire by ligating different parts. Certainly, the actual application is not limited to the following methods.

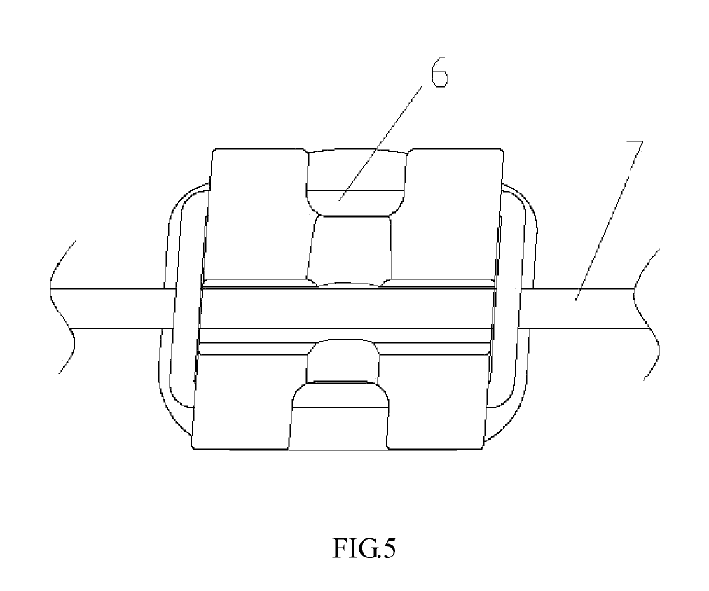

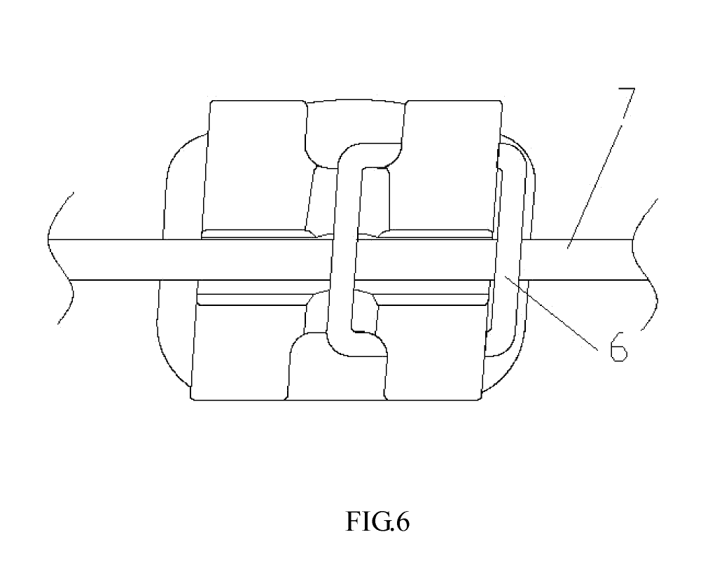

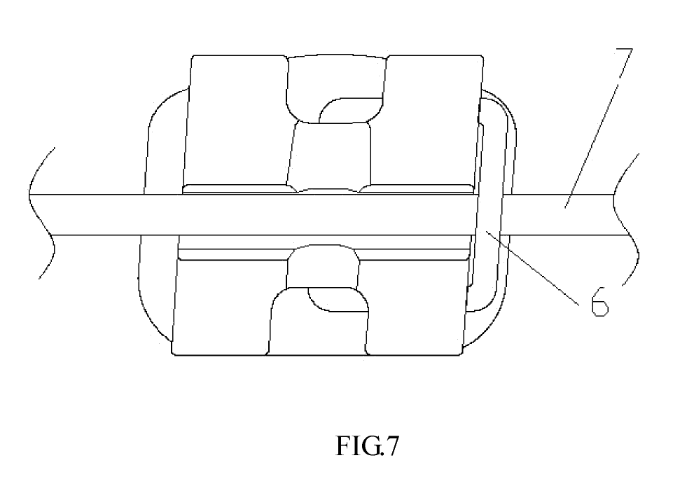

As shown in FIG. 4, only the ligature hole 5 and the ligature wire locating grooves 41, 42 may be ligated. There is a gap between the arch wire 7 and the bracket, and the arch wire 7 and a ligature wire 6 are in point contact only, generating little friction resistance. Further, the arch wire 7 in the bracket is prolonged, making the correction force gentler, such that the movement of the tooth can be accelerated better. Certainly, this kind of ligation method can also be achieved by the movable lock 12 directly. As shown in FIG. 8, the movable lock the ligature wire 6 is passing through the arch wire locating grooves 41, 42 and crossing over the arch wire 7 to ligate one half of the wings at the lower part 12 is directly inserted in the ligature hole 5 and the ligature wire locating groove 41, 42, facilitating the operation and avoiding the complicated operation of the ligature wire 6, such that the operation time can be greatly reduced. As shown in FIG. 5, the friction force between an individual tooth and the arch wire 7 can be increased by the tight ligation at the lower part of the gingival wing, thereby selectively controlling the movement of the individual tooth. As shown in FIG. 6, the ligature wire 6 is passing through the arch wire locating grooves 41, 42 and crossing over the arch wire 7 to ligate one half of the wings at the lower part and the ligation is tighter due to the height difference between the bottom of the ligature wire locating trench 10 and the bottom of the arch wire groove 2, thus to correct torsion of the tooth, thereby adjusting the position of the individual tooth more precisely. As shown in FIG. 7, the ligature wire 6 is passing through the ligature hole 5 and crossing over the arch wire 7 to ligate one half of the wings, the ligation is tighter due to the height difference between the ligature hole 5 and the bottom of the arch wire groove 2, thus to correct torsion of the tooth, thereby adjusting the position of the individual tooth more precisely.

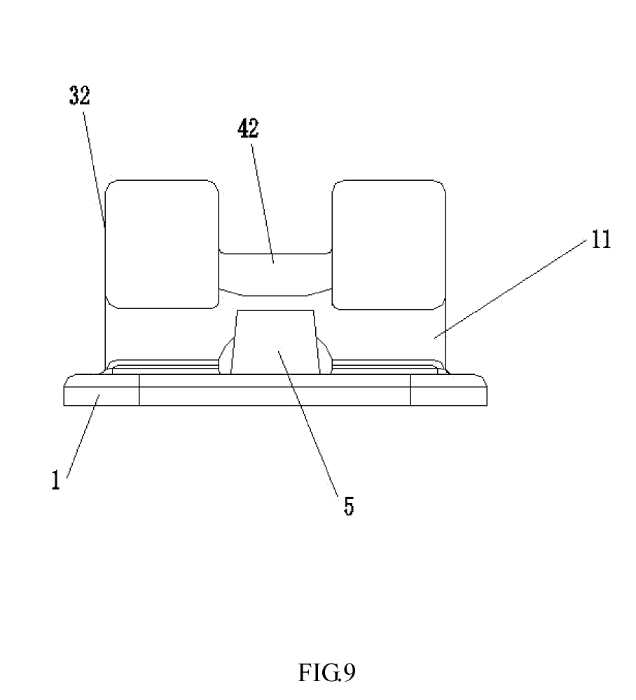

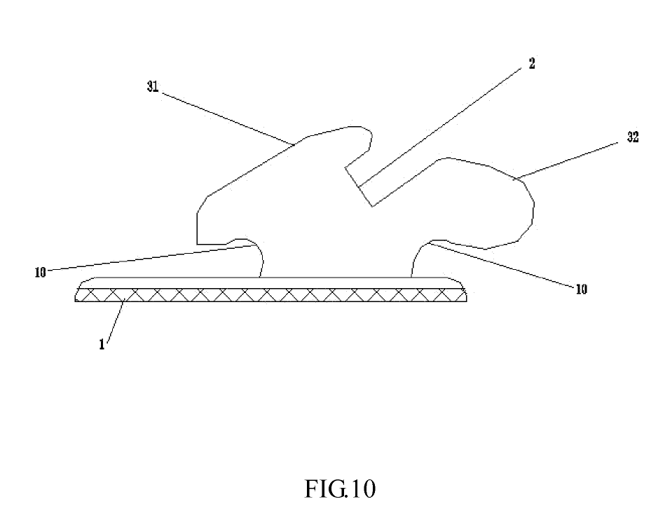

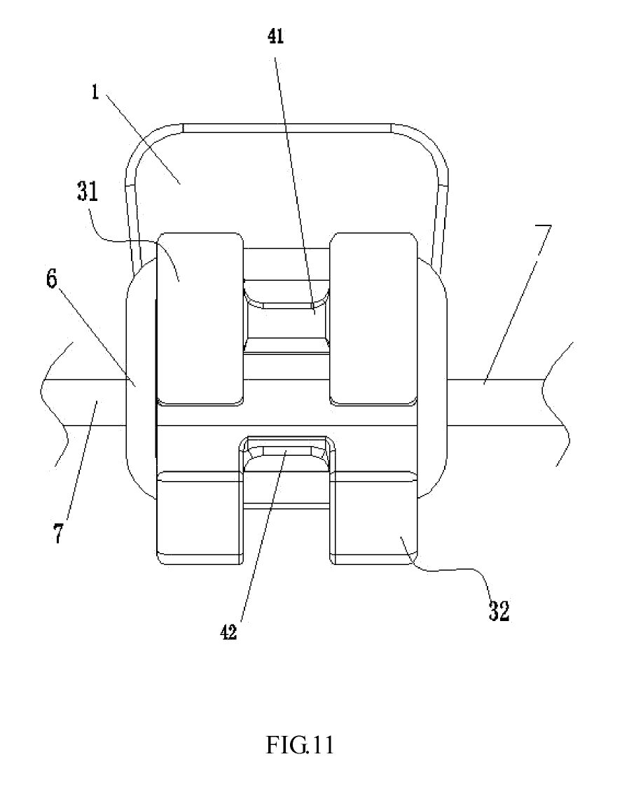

As shown in FIG. 9 and FIG. 10, the lingual bracket for correcting dentognathic deformity of the invention includes a substrate plate 1, a bracket body 11, and two working wings 31, 32. The bracket body 11 has an arch wire groove 2, and the working wing 31 and the working wing 32 are located at two sides of the arch wire groove 2. As shown in FIG. 11, The working wing 31 has a ligature wire locating groove 41, and the working wing 32 has a ligature wire locating groove 42. The groove bottom central line of the ligature wire locating groove 41 and the groove bottom central line of the ligature wire locating groove 42 are located on a same straight line. The same straight line is vertical to the arch wire groove 2. As shown in FIG. 9, the bracket body 11 further has a ligature hole 5 vertical to the arch wire groove 2 and penetrating through the bracket body 11. A vertical distance from a bottom surface of the arch wire groove 2 to an upper surface of the substrate plate 1 is larger than a height of the ligature hole 5. The ligature hole 5 is located under the ligature wire locating groove 41 and the ligature wire locating groove 42. Further, as shown in FIG. 10, a vertical distance from a bottom of the ligature wire locating trench 10 to the upper surface of the substrate plate 1 is smaller than the vertical distance from the bottom surface of the arch wire groove 2 to the upper surface of the substrate plate 1.

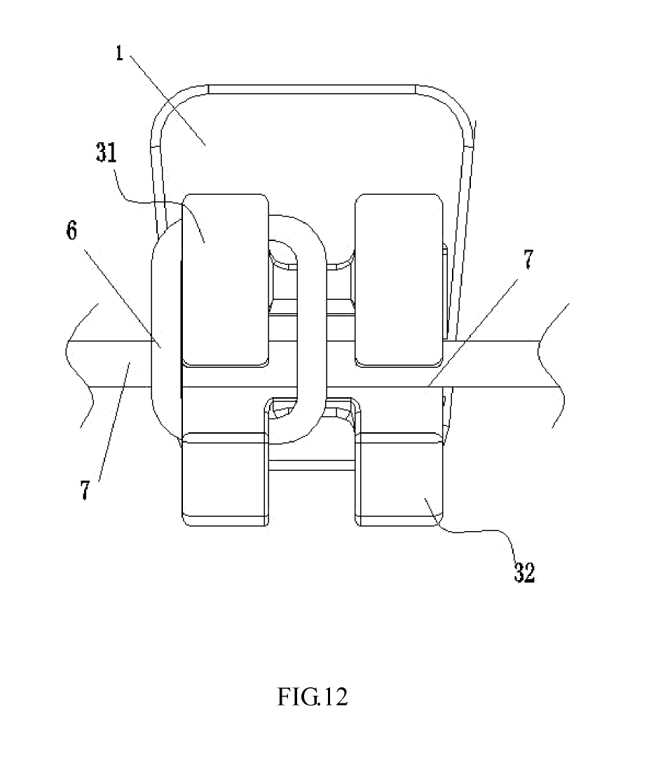

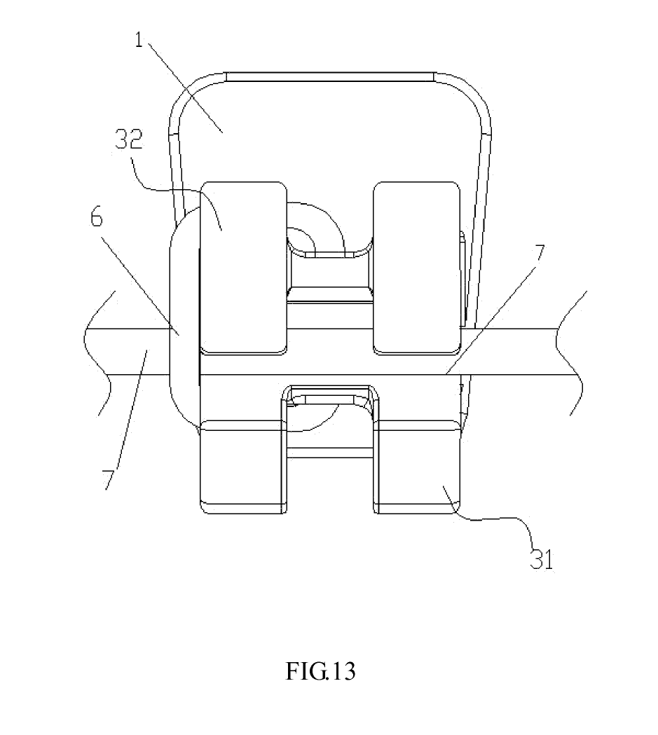

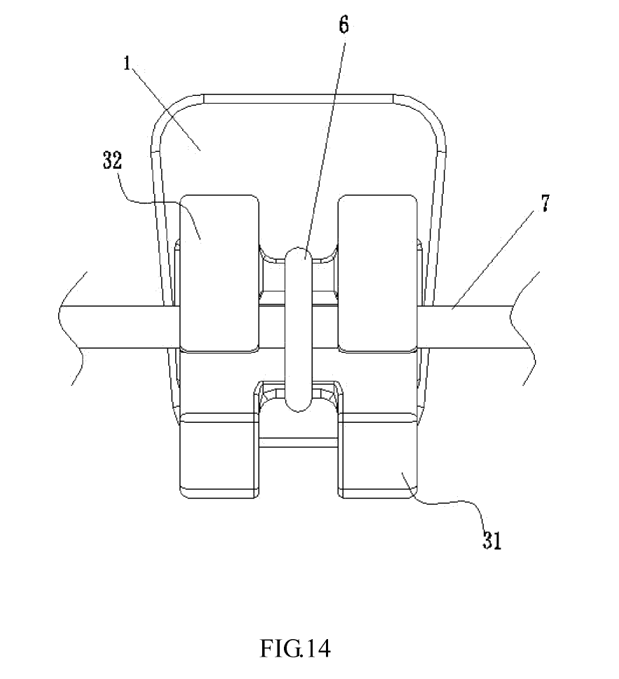

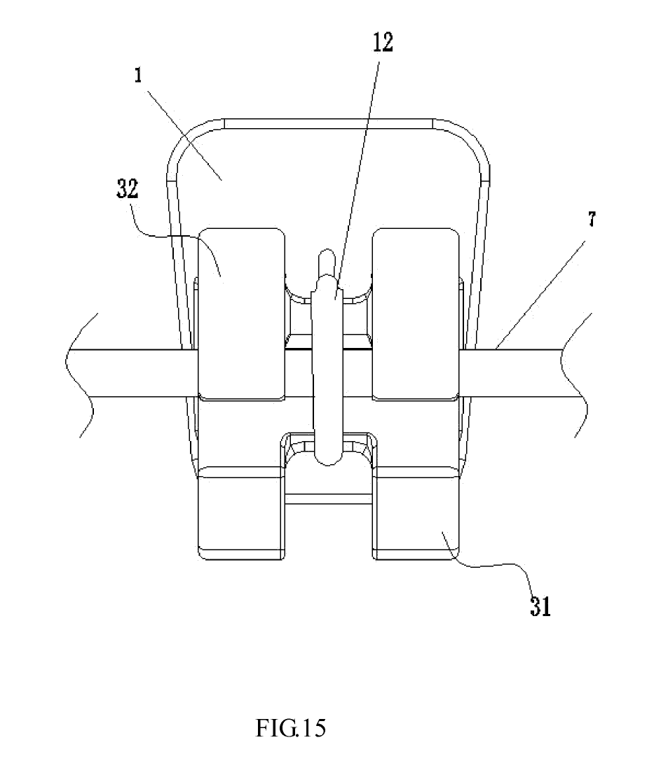

As shown in FIG. 14, only the ligature hole 5 and the ligature wire locating grooves 41, 42 may be ligated. There is a gap between the arch wire 7 and the bracket, and the arch wire 7 and a ligature wire 6 are in point contact only, generating little friction resistance. Further, the arch wire 7 in the bracket is prolonged, making the correction force gentler, such that the movement of the tooth can be accelerated better. Certainly, this kind of ligation method can also be achieved by a movable lock directly. As shown in FIG. 15, the movable lock 12 is directly inserted in the ligature hole 5 and the ligature wire locating groove, facilitating the operation and avoiding the complicated operation of the ligature wire, such that the operation time can be greatly reduced. As shown in FIG. 11, the friction force between an individual tooth and the arch wire 7 can be increased by the tight ligation at the lower part of the gingival wing, thereby selectively controlling the movement of the individual tooth. As shown in FIG. 12, the ligature wire 6 is passing through the arch wire locating grooves 41, 42 and crossing over the arch wire 7 to ligate one half of the wings at the lower part, and the ligation is tighter due to the height difference between the bottom of the ligature wire locating trench 10 and the bottom of the arch wire groove 2, thus to correct torsion of the tooth, thereby adjusting the position of the individual tooth more precisely. As shown in FIG. 13, the ligature wire 6 is passing through the ligature hole 5 and crossing over the arch wire 7 to ligate one half of the wings, the ligation is tighter due to the height difference between the ligature hole 5 and the bottom of the bottom of the arch wire groove 2, thus to correct torsion of the tooth, thereby adjusting the position of the individual tooth more precisely.

When the lingual bracket for correcting dentognathic deformity is used, for a central incisor or a lateral incisor, the size of the cross-sectional area of the arch wire groove 2 is 0.018*0.025 inches, and for a canine tooth, a premolar, or a molar, the size of the cross-sectional area of the arch wire groove 2 is 0.020*0.025 inches. This feature achieves the following benefits. When closing the gap in dental extraction by a sliding method, the left space of the arch wire 7 in the groove of the posterior teeth is larger, while the left space in the groove of the anterior teeth is smaller, such that the torque on the anterior teeth can be controlled, and at the same time, sliding can be achieved smoothly in the groove of the posterior teeth.

What is claimed is:

1. A bracket for correcting dentognathic deformity, comprising:
a substrate plate;
a bracket body, having an arch wire groove; and
two working wings, located at two sides of the arch wire groove, wherein a lower part of the working wings has a ligature wire locating trench, each of the working wings has a ligature wire locating groove, groove bottom central lines of the ligature wire locating grooves of the two working wings are located on a same straight line, the bracket body has a ligature hole vertical to the arch wire groove and penetrating through the bracket body, and a vertical distance from a bottom surface of the arch wire groove to an upper surface of the substrate plate is larger than a height of the ligature hole.

2. The bracket for correcting dentognathic deformity according to claim 1, wherein the ligature hole is located under the ligature wire locating grooves.

3. The bracket for correcting dentognathic deformity according to claim 1, wherein the same straight line formed by the groove bottom central lines of the ligature wire locating grooves of the two working wings is vertical to the arch wire groove.

4. The bracket for correcting dentognathic deformity according to claim 1, wherein when the bracket is used for a central incisor or a lateral incisor, the size of the cross-sectional area of the arch wire groove is 0.018*0.025 inches, and when the bracket is used for a canine tooth, a premolar, or a molar, the size of the cross-sectional area of the arch wire groove is 0.020*0.025 inches.

5. The bracket for correcting dentognathic deformity according to claim 4, wherein the ligature hole is located under the ligature wire locating grooves.

6. The bracket for correcting dentognathic deformity according to claim 4, wherein the same straight line formed by the groove bottom central lines of the ligature wire locating grooves of the two working wings is vertical to the arch wire groove.

7. The bracket for correcting dentognathic deformity according to claim 1, wherein a vertical distance from a bottom of the ligature wire locating trench to the upper surface of the substrate plate is smaller than the vertical distance from the bottom surface of the arch wire groove to the upper surface of the substrate plate.

8. The bracket for correcting dentognathic deformity according to claim 7, wherein the ligature hole is located under the ligature wire locating grooves.

9. The bracket for correcting dentognathic deformity according to claim 7, wherein when the bracket is used for a central incisor or a lateral incisor, the size of the cross-sectional area of the arch wire groove is 0.018*0.025 inches, and when the bracket is used for a canine tooth, a premolar, or a molar, the size of the cross-sectional area of the arch wire groove is 0.020*0.025 inches.

10. The bracket for correcting dentognathic deformity according to claim 7, wherein the same straight line formed by the groove bottom central lines of the ligature wire locating grooves of the two working wings is vertical to the arch wire groove.

11. A movable lock, being C-shaped and inserted with one end into the ligature hole and with the other end into the ligature wire locating grooves.

12. The movable lock according to claim 11, wherein the movable lock is made of an elastic material.
